(19) United States
(12) Patent Application Publication
(10) Pub. No.: US 2005/0171219 A1
(43) Pub. Date: Aug. 4, 2005

(54) Beading

(76) Inventor: Curt Thies, Henderson, NV (US)

Correspondence Address: FISH & RICHARDSON PC, 225 FRANKLIN ST, BOSTON, MA, 02110, US

(21) Appl. No.: 10/769,210

(22) Filed: Jan. 30, 2004

(51) Int. Cl. C08C 1/00

(52) U.S. Cl. 520/1

(57) ABSTRACT

Dry beads that swell rapidly when placed in contact with aqueous media.

The present invention relates in general to beading and more particularly concerns novel articles and methods of making characterized by originally dry beads that swell rapidly when placed in contact with aqueous media to become expanded beads.

### BACKGROUND OF THE INVENTION

Small polymer beads that range in sizes from 1 μm to over 1000 μm are known.

### SUMMARY OF THE INVENTION

According to the invention, polymer beads swell rapidly when placed in contact with aqueous media to become expanded gel beads. The beads may be spherical, largely spherical or ogival or elongated. The swelling may be rapid so fast dimensional changes of the bead are largely complete within 5-20 minutes immersion in aqueous media. A feature of the invention for achieving rapid swelling includes incorporating within the initial dry bead structure a diluent that is highly water-soluble. Preferably the diluent is generally present in equal or larger amounts than the polymer that provides a gel structure to the water-swollen beads, typically greater than or equal to 50 wt. %, but as low as 30-40 wt. %. The beads may be in a range of sizes from 1 μm to over 1,000 μm and can have a polydisperse size distribution or very narrow size distribution. Typically they are produced as a dry free-flow powder that may be stored in the dry state until use. Once the beads are placed in contact with aqueous media, they swell significantly and rapidly to thereby produce soft deformable gel beads. A feature of the beads is that when highly swollen in aqueous media, they may be difficult to see visually and have minimal effect on the optical properties in the medium in which they are immersed to allow analyses of the immersion medium that contains the swollen beads through spectroscopic means without significant interference caused by the beads. The beads may contain an agent released when swelling. These agents may be, for example, a biologically active agent, marker dye, salt or other ingredient released rapidly at the time of immersion. Alternately, the agents may remain entrapped within the bead either not to be released over an indefinite period (e.g., an insoluble salt) or to be released slowly over a prolonged period. The agent may be initially simply dissolved, dispersed throughout the bead and thereby entrapped, or may be dispersed in one or more small microcapsules on nanocapsules places within the bead at the time of manufacture.

By rapid is meant that primary geometry changes of the bead due to swelling caused by the aqueous medium occur within 5 to 20 minutes after the beads are placed in contact with an aqueous medium. Bead dimensional changes occurring after this time frame normally are small.

It is an important object of this invention to provide beads that swell rapidly when placed in contact with aqueous media and methods of making and using them.

Other features, objects and advantages of the invention will become apparent from the following detailed description.

### DETAILED DESCRIPION

Rapid swelling beads consist of an intimate mixture of polymer and diluent. The polymer is swollen by aqueous media at the desired use temperature, but is not fully soluble in said media. The diluent is fully soluble in aqueous media. Candidate polymers include agarose, agarose derivatives, pectin, fully hydrolyzed poly(vinyl alcohol), gelatin, gellum and other acknowledged polymers or combinations of polymers that form gels in aqueous media. Table 1 lists several candidate polymers. No known chemical crosslinking reaction(s) is used to produce the beads. The candidate polymers form gels in aqueous media due to so-called secondary valence forces that exist between the polymer molecules. In all cases, heating the polymers to elevated temperatures in aqueous media “melts” the gel structure thereby destroying the gel structure and completely solubilizing the polymer(s) used to form the gel. Conversely, cooling hot polymer solutions leads to gel formation since it is under cooling conditions that the secondary valence interactions cause gel formation. Since the gels of interest are formed by secondary valence interactions, the gel structure is reversible and can be formed by cooling and destroyed by heating a number of times. This means water-swollen beads can be destroyed by simply heating such beads above the melting polymer gel.

Formation of beads from gel-forming polymers is well established. However, the incorporation at the time of bead formation a significant amount of non-gelling, water-soluble diluent material into a polymer bead is not practiced or anticipated by previous workers. For the purpose of this disclosure, a significant amount of diluent material means that the diluent/polymer ratio in a dry bad ranges from 4:6 to 9:1 (w/w). Candidate diluent materials must be readily or freely soluble in water. It must not take much time to solubilize them in water. Candidate diluents, when present in large amounts relative to the amount of gel-forming polymer, cannot destroy the ability of the gel-forming polymer to produce a gel. Suitable diluents that pass this specification have a MW below approximately 20,000 daltons. Table 1 lists a number of candidate diluents.

Diluents cause polymer beads to swell rapidly in aqueous media, because they have comparatively low molecular weight and are highly water-soluble. They are not chemically bound to the gel structure or permanently entrapped in the bead, but are present initially in a bead as a homogeneous mixture with the gel-forming polymer. The latter provides the water-swollen bead with its gel structure when it is placed in aqueous media. When a bead is immersed in aqueous media, the diluent material within the bead is rapidly hydrated and solubilized by the water present in such media. This rapidly creates a large concentration gradient between the bead interior and the aqueous media in which the bead is immersed. That is, when a bead is immersed in water, the interior of the bead is rapidly hydrated and solubilized by the water present in such media. This rapidly creates a large concentration gradient between the bead interior and the aqueous media in which the bead is immersed. That is, when a bead is immersed in water, the interior of the bead quickly become a concentrated aqueous solution of diluent located within the polymer gel structure while initially there is essentially no diluent outside the bead. The high concentration of diluent within the bead and absence of diluent initially outside the bead sets up a large osmotic pressure gradient between the inside and outside of the bead. It is this pressure gradient that causes the bead to swell rapidly. Once the diluent is fully dissolved within a bead, it diffuses from the bead into the exterior aqueous medium in which the bead is placed thereby reducing the driving force for swelling of the bead. The faster this reduction in osmotic pressure gradient occurs due to diffusion of dissolved diluent from the beads, the faster the bead reaches its equilibrium swelling volume when it is immersed in aqueous media. Said water-soluble diluent material causes rapid bed swelling because it initially creates a finite osmotic pressure gradient within the bead. When a dry bead is placed in aqueous media, water rapdily diffuses into the bead. The diluent material dissolves rapidly in the water (Note: lower molecular weight materials dissolve more rapidly in water than higher MW materials. The latter require a finite hydration/swelling time) thereby causing an osmotic pressure gradient between the interior and exterior of the bead. This, in turn, causes the bead to swell rapidly. The solubilized water-soluble diluent material may subsequently diffuse from the bead to thereby leave behind a highly swollen gel bead that is largely water and the gel-forming polymer.

A variation of this type of bead formation involves including in the bead at the time of bead formation a “particle” (e.g., a nanoparticle, microcapsules, etc.) which is entrapped in the bead even after the bead is swollen. Said “particle” entrapped in the bead can release active agent over a prolonged period at the site when the swollen bead is placed. In this manner, the rapidly swollen bead becomes a device for providing prolonged release of active material such as a biologically active agent. The “particle(s)” permanently entrapped in swollen beads may be a radio opaque tracking agent. Said tracking agent may exist as of water-insoluble particles or it could be a water-soluble tracking agent that is immobilized in a carrier particle such as a nanocapsule or microcapsule or microsphere.

Candidate diluent materials that are the subject of this disclosure include various sugars (dextrose, maltose, sucrose, etc.), water-soluble hydrolyzed starch fragments known as maltodextrins and corn syrup solids, low molecular weight polymers known as poly(ethylene glycols), and dextrans. Candidate materials for use as diluents must have sufficiently low MW that they do not interfere with gel formation by the gel-forming polymer. To date, it has been observed experimentally that suitable diluent materials have a MW less than approximately 20,000 daltans.

TABLE 1
List of candidate gel-forming polymers and suitable diluents
for forming beads discussed in this disclosure.

| Gel forming polymer | Diluent material |
|---|---|
| Agarose | sugars like sucrose, maltose, dextrose, etc. |
| Fully hydrolyzed | poly(ethylene glycol) <20,000 MW |
| (95-99%) | |
| poly(vinyl alcohol) | |
| Gelatin | water-soluble starch hydrolysates <20,000 MW |
| Pectin | dextrans <20,000 MW |
| Gellum | |
| Poly(vinyl alcohol) | |

Note:
Combinations of gel-forming polymers may be used (e.g., agarose + a second gelling polymer) as may combinations of water-soluble diluents (e.g., dextrose + poly(ethylene glycol)).

Water-in-Oil Process for Bead Formation

In this process, an aqueous solution that contains the gel-forming polymer in solution (i.e., not as a gel) is emulsified in a water-immiscible oil initially at a temperature equal to or above the gelation temperature of the polymer that forms the desired gel structure. Said oil is then allowed to cool to a temperature below that needed for gelation so that the polymer gels. The emulsion is stirred continuously at this lower temperature until the water of the dispersed phase has evaporated to such an extent that solid beads can be harvested from the stirred beaker. Alternately, the gel beads are harvested from the emulsion by extraction with a solvent that is miscible with water and the water-immiscible oil (e.g., acetone, ethanol, etc.)

Droplet Extrusion Method

In this process, droplets that contain a solution of gel-forming polymer along with diluent(s) or any added active ingredients), are extruded drop-wise one at a time from an orifice into a receiving bath that contains a liquid or liquid mixture that is immiscible with water and enables the extruded droplet to gel. Water is subsequently removed fromt he extruded gel droplets by evaporation and/or extraction. The receiving bath is chilled by placing it in a suitably cold environment prior to extrusion. Said liquid is maintained chilled throughout the extrusion process. Further, the length of fall distance of chilled liquid through which the droplets falls must be sufficient to enable the extrude droplets to gel sufficiently that they do not coalesce when they reach the bottom of the chilled receiving liquid and contact previously extruded droplets. The extruded gel beads can be dried by solvent extraction and/or evaporation of water as is done in the emulsion version of bead formation (A above).

Examples of Beads Formed by Water-in-Oil Emulsion Process

1. Preparation of Agarose-Dextrose (1/3 w/w ratio) beads: Agarose (Sigma, St. Louis, Mo.) (3.0 gm) was dissolved with continuous stirring in 50 ml water heated to >90° C. Once solution of the agarose was complete, dextrose (9 gm) was added with mixing and allowed to dissolve in the hot aqueous solution. The resulting clear solution was subsequently added to a stirred 800 ml open beaker that contained 400 ml of a highly purified medium chain triglyceride (Myglyol 812, Sasol, Houston, Tex.) at 65° C. the Miglyol is defined as the oil phase and contained 0.025% lecithin (Central Soya, Fort Wayne, Ind.) as an emulsifier. The resulting water-in-oil emulsion was cooled with continuous stirring to ambient temperature (20° C.) without the aid of an external cooling source. The gel beads produced by this cooling step were taken to dryness at 20° C. by continuously stirring the initial water-in-oil emulsion for 4 days at 20° C. During this prolonged stirring period, water evaporated from the system to thereby produce solid spherical agarose/dextrose beads. After stirring was stopped, the beads settled, the oil phase was decanted off and residual oil was removed from the surface of the beads by washing with n-heptane. Other washing solvents that could be used include h-hexane and cyclohexane.

2. Preparation of Gelatin-Dextrose (1/1/w/w ratio) beads: Limed ossein gelatin (100 Bloom, Rousselot Gelatin) (50 gm) was dissolved in 50° C. water. Dextrose (50 gm) was subsequently added to this solution. The resulting mixture was added to 300 ml Miglyol 812 (Sasol, Houston, Tex.) in a 1 L beaker. The oil (i.e., Miglyol) was heated to 77° C. and contained 0.25% lecithin (Central Soya, Fort Wayne, Ind.) as an emulsifier. The resulting water-in-oil emulsion was cooled with continuous stirring to ambient temperature (20° C.) without the aid of an external cooling source. The gel beads produced by this cooling step were taken to dryness at 20° C. by continuously stirring the initial water-in-oil emulsion for 4 days at 20° C. During this prolong stirring period, water evaporated from the system to thereby produce solid spherical gelatin/dextrose beads. After stirring was stopped, the beads settled, the oil phase was decanted off and residual oil was removed from the surface of the beads by washing with n-heptane. Other suitable washing solvents include h-hexane and cyclohexane.

3. Preparation of Agarose-Dextrose (1/1.28 w/w ratio) beads: Agarose (Sigma, St. Louis, Mo.) (8.0 gm) was dissolved with continuous stirring in 150 ml water heted to >90° C. Once solution of the agarose was complete, dextrose (10.2 gm) was added with mixing and allowed to dissolve in the hot aqueous solution. The resulting clear solution was subsequently added to a stirred 1 L open beaker that contained 800 ml of an oil phase, highly purified medium chain triglyceride (Miglyol 812, Sasol, Houston, Tex.) at 67° C. The oil phase contained 0.05% lecithin (Central Soya, Fort Wayne, Ind.) as an emulsifier. The resulting water-in-oil emulsion was cooled with continuous stirring to ambient temperature (20° C.) without the aid of an external cooling source. The gel beads produced by this cooling step were taken to dryness at 20° C. by continuously stirring the initial water-in-oil emulsion for 4 days at 20° C. During this prolonged stirring period, water evaporated from the system to thereby produce solid agarose/dextrose beads. After stirring was stopped, the beads settled, the oil phase was decanted off and residual oil was removed from the surface of the beads by washing with n-heptane. Other washing solvents that could be used include h-hexane and cyclohexane.

4. Preparation of Agarose-Maltodextrin (1/1 w/w ratio) beads: Agarose (Sigma, St. Lous, Mo.) (8.0 gm) was dissolved with continuous stirring in 150 ml water heated to >90° C. Once solution of the agarose was complete, a maltodextrin with (Maltrin 150, Grain Processing, IA) (10.2 gm) was added with mixing and allowed to dissolve in the hot aqueous solution. The resulting clear solution was subsequently added to a stirred 1 L open beaker that contained 800 ml of an oil phase, highly purified medium chain triglyceride (Miglyol 812, Sasol, Houston, Tex.) at 67° C. The oil phase contained 0.25% lecithin (Central Soya, Fort Wayne, Ind.) as an emulsifier. The resulting water-in-oil emulsion was cooled with continuous stirring to ambient temperature (20° C.) without the aid of an external cooling source. The gel beads produced by this cooling step were taken to dryness at 20° C. by continuously stirring the initial water-in-oil emulsion for 4 days at 20° C. During this prolonged stirring period, water evaporated from the system to thereby produce solid agarose/maltodextrin beads. After stirring was stopped, the beads settled, the oil phase was decanted off and residual oil was removed from the surface of the beads by washing with n-heptane. Other washing solvents that could be used include h-hexane and cyclohexane.

5. Preparation of Agarose-Dextran (1/1 w/w ratio) beads: Agarose (Sigma, St. Louis, Mo.) (8.0 gm) was dissolved with continuous stirring in 150 ml water heated to >90° C. Once solution of the agarose was complete, dextran (9,000 molecular weight, Sigma, St. Louis, Mo.) (10.2 gm) was added with mixing and allowed to dissolve in the hot aqueous solution. The resulting clear solution was subsequently added to a stirred 1 L open beaker that contained 800 ml of an oil phase, highly purified medium chain triglyceride (Miglyol 812, Sasol, Houston, Tex.) at 67° C. The oil phase contained 0.25% lecithin (Central Soya, Fort Wayne, Ind.) as an emulsifier. The resulting water-in-oil emulsion was cooled with continuous stirring to ambient temperature (20° C.) without the aid of an external cooling source. The gel beads produced by this cooling step were taken to dryness at 20° C. by continuously stirring the initial water-in-oil emulsion for 4 days at 20° C. During this prolonged stirring period, water evaporated from the system to thereby produce solid agarose/dextran beads. After stirring was stopped, the beads settled, the oil phase was decanted off and residual oil was removed from the surface of the beads by washing with n-heptane. Other washing solvents that could be used include h-hexane and cyclohexane.

6. Preparation of Agarose-(Poly(ethylene glycol (1/3 w/w ratio) beads: Poly(ethylene glycol) (Sigma, St. Louis, Mo.) (1.0 gm) was dissolved with continuous stirring in 25 ml water heated to >90° C. Once solution of the agarose was complete, poly(ethylene glycol) (8,000 molecular weight, Polysciences, Warrenton, Pa.) (3 gm) was added with mixing and allowed to dissolve in the hot aqueous solution. The resulting clear solution was subsequently extruded dropwise into a 100 ml graduated cylinder filled with chilled (approximately −10° C.) dibutyl sebacate (Sigma, St. Louis, Mo.) free of surfactant. The extruded droplets gelled by the time they fell to the bottom of the column of receiving liquid. Upon completion of extrusion, the receiving liquid was transferred to an open beaker that was stirred until water evaporation was sufficiently complete that dry beads could be harvested. After stirring was stopped, the beads settled, the oil phase was decanted off and residual oil was removed from the surface of the beads by washing with n-heptane. Other washing solvents that could be used include h-hexane and cyclohexane.

Description of Bead Formation by the Droplet Extrusion Process and Specific Example

Step 1. Dissolve the gel-forming polymer (e.g., gelatin, agarose, etc.) the temperature of dissolution must be sufficient to produce a clear solution that does not gel during handling. For example, 40-50° C. for gelatin; >90° C. for agarose, although once an agarose solution is formed, it may be allowed to cool to 70-80° C., since agarose once in solution does not gel until it reaches approximately 60° C. In most cases heated solution once formed should be used relatively rapidly (within hours after formation), because on prolonged heating many candidate polymers that gel degrade significantly. Heated solutions once formed can be kept heated by storing them in some type of commercially available product or unique heated chamber (i.e., an oven) until used.

Step 2. The desired diluent(s) (e.g., sugar, polyethylene glycol, etc.) and active ingredient(s) is added to this heated solution and the resulting mixture is mixed well.

Step 3. A chilled receiving liquid that is water-immiscible is formed by placing said liquid in a chilled environment (e.g., a freezer, dry ice bath, cooling unit). The temperature of chilling can vary with the nature of the liquid used as, but cannot be below the freezing point of the receiving fluid.

Step 4. The warmed solution of gel-forming polymer along with desired diluent(s) and active agent(s) is placed in the extrusion device (e.g., a syringe, warmed pumping unit through which the desired solution is pumped to an extrusion nozzle). The chilled receiving bath is placed in a container located below the extruding nozzle and extrusion is started. The heated droplets of extruded solution fall through the column of chilled receiving liquid to form gel beads which are subsequently harvested and dried.

Specific Example: Preparation of Agarose-(Poly(ethylene glycol (1/3 w/w ratio) beads: Poly(ethylene glycol) (Sigma, St. Louis, Mo.) (1.0 gm) was dissolved with continuous stirring in 25 ml water heated to >90° C. Once solution f the agarose was complete, poly(ethylene glycol) (8,000 molecular weight, Polysciences, Warrenton, Pa.) (3 gm) was added with mixing and allowed to dissolve in the hot aqueous solution. The resulting clear solution was subsequently extruded dropwise into a 100 ml graduated cylinder filled with chilled (approximately −10° C.) dibutyl sebacate (Sigma, St. Louis, Mo.) free of surfactant. The extruded droplets gelled by the time they fell to the bottom of the column of receiving liquid. Upon completion of extrusion, the receiving liquid was transferred to an open beaker that was stirred until water evaporation was sufficiently complete that dry beads could be harvested. After stirring was stopped, the beads settled, the oil phase was decanted off and residual oil was removed from the surface of the beads by washing with n-heptane. Other washing solvents that could be used include h-hexane and cyclohexane.

There are a number of uses or applications for the beads. Application 1. Deformable, water-swollen gel beads can be transported through the circulatory system of humans and/or animals either by the body's own inherent transport mechanism(s) or via intra arterial infusion therapy. In the latter case, the beads are administered in vivo through a catheter and placed at a specific point in the body. A combination of both mechanisms could also be used. The purpose of bead placement in the body could be to simply provide physical blockage to blood or other body fluid flow in vivo. This may be desired for a finite or indefinite period in order to achieve a specific biological response. Candidate biological responses can be the restriction of blood flow to one or more specific points in the body wherein said restriction alone reduces the formation of tumor(s) or alter the rate of tumor formation. A specific example would be the use of intrarterial infusion therapy with the swollen gel beads to eliminate fibroids in human females. In such applications, the gel bead would contain no active agent. Their function is to solely block flow of body fluids at the point in the body where they are placed and/or lodged. Another application is to have the beads swell rapidly and stop/prevent further hemorrhaging within a body cavity (e.g., the brain) or upon external placement at a site where a significant laceration has occurred.

Application 2. Intra-arterial infusion therapy with swollen gel beads that contain a biologically active agent can also be carried out. The methodology whereby the beads are placed in a specific part of the body is the same as that described in Application 1, but now the beads contain one or more active agents that are released from the gel beads by diffusion. Extended release of one or more biologically active agents initially carried by the beads can accompany their placement at specific point(s) in the body. A marker substance (e.g., a radio opaque agent or dye) can be contained within the beads either with or without biologically active agents also present within the beads. The markers would provide surgeons carrying out intra-arterial infusion a means of “tracking” where the beads are located within the body.

Application 3. Since the beads swell rapidly in aqueous media thereby rapidly sorbing a finite amount of biological media (primarily water) at the point they are placed, while simultaneously expanding significantly, they can serve as a hemostat to stop/prevent further hemorrhaging within a body cavity (e.g., the brain) or upon external placement at a site where a significant laceration has occurred.

Application 4. Beads of controlled or well-defined size can carry a well-defined amount of desired material or active agent into a defined, small (micro) volume element or cavity or be inserted into the fluid flow system of a microfluidics system thereby providing said cavity or microfluidics system with a defined amount of active agent. Candidate active agents may be one or more dyes (laser susceptible/fluorescent), various reactant species such as salts, proteins, enzymes, sugars, polysaccharides or combinations of these or any other species whose rapid or controlled release into a small cavity is desired. Such release can enable one, several simultaneous, or a sequential series of reactions to occur in the selected small volume element.

It is evident that those skilled in the art may now make numerous departures from, modifications of and uses of the specific articles and techniques disclosed herein. Consequently, the invention is to be construed as embracing each and every novel feature and novel combination of features present in or possessed by the apparatus and techniques herein disclosed.

1. Polymer bead characterized by swelling rapidly when placed in contact with aqueous media.

2. Polymer beads in accordance with claim 1 that are a dry-free-flow powder.

3. A method of making the beads of claim 1 by water-in-oil process.

4. The method of making the beads of claim 1 by the droplet extrusion method.

5. Agarose-dextrose beads made by the method of claim 3.

6. Gelatin-dextrose beads made by the method of claim 3.

7. Agarose-maltodextrin beads made by the method of claim 3.

8. Agarose-dextran beads made by the method of claim 3.

9. Agarose-Poly (ethylene glycol) beads made by the method of claim 3.

10. Agarose-Poly (ethylene glycol) beads made by the method of claim 4.

11. The method of using the beads of claim 1 in accordance with Application 1.

12. The method of using the beads of claim 1 in accordance with Application 2.

13. The method of using the beads of claim 1 in accordance with Application 3.

14. The method of using the beads of claim 1 in accordance with Application 4.

15. Each and every novel feature and novel combination of features present in or possessed by the article and techniques herein disclosed.
